(19) United States
(12) Patent Application Publication
(10) Pub. No.: US 2024/0356365 A1
(43) Pub. Date: Oct. 24, 2024

(54) Auxiliary Gasoline Vehicle Booster

(71) Applicants: Bai Ye Industrial Co., Ltd., Huatan Township (TW); Amplenergy Technology Co., Ltd., New Taipei City (TW)

(72) Inventor: Jack Wang, New Taipei City (TW)

(21) Appl. No.: 18/305,471

(22) Filed: Apr. 24, 2023

(51) Int. Cl. H02J 7/34; B60L 1/00; H02J 7/14

(52) U.S. Cl. CPC H02J 7/345; B60L 1/006; H02J 7/1423; H01M 10/052; H01M 10/06; H02J 2207/50

(57) ABSTRACT

An auxiliary gasoline vehicle booster includes a box (10) and a first energy storage element (20) mounted in the box. The box has a side provided with an external cord (11). The external cord is electrically connected in parallel with a generator (300) and a lead-acid battery (200) of a gasoline vehicle. The first energy storage element is electrically connected with the external cord. The first energy storage element is used to receive and store an electric energy supplied by the generator of the gasoline vehicle. The first energy storage element is used to supply an electric power to the gasoline vehicle. The first energy storage element has a voltage ranged between that of the generator and that of the lead-acid battery.

### BACKGROUND OF THE INVENTION

### Field of the Invention

The present invention relates to an auxiliary power supply device for a petro car and, more particularly, to an auxiliary gasoline vehicle booster.

### Description of the Related Art

A conventional gasoline car in accordance with the prior art shown in FIGS. 1-3 comprises a lead-acid battery 1, starter motor 2, an ignition device 3, an engine 4, a generator 5, and a rectifier 6. When the user wishes to start the engine 4, the lead-acid battery 1 outputs a large current to the starter motor 2, and provides an electric power to the ignition device 3 at the same time, so that the starter motor 2 and the ignition device 3 can start the engine 4 to run. After the engine 4 is started and operated, the engine 4 drives the generator 5 to generate an electric energy which is rectified by the rectifier 6, and then stored in the lead-acid battery 1. The lead-acid battery 1 not only provides the electric power to the gasoline vehicle, but also supplements the electricity when the generator 5 is insufficient in power generation.

Referring to FIG. 2, after the engine 4 is started and operated, the generator 5 is operated to produce a current which is rectified to produce a voltage waveform A. The voltage of the generator 5 is about 14.5V. The lead-acid battery 1 is charged by the generator 5 and forms a voltage waveform B. The voltage of the lead-acid battery 1 is about 12.4V. However, the voltage waveform B of the lead-acid battery 1 is charged by the generator 5 to form a ripple waveform, so that the ignition voltage of the ignition device 3 is relatively unstable due to the excessive voltage drop.

Referring to FIG. 3, the spark plug 7 in the ignition device 3 is ignited unstably so that ignition of the spark plug 7 is too large or too small, thereby causing a slow throttle response, carbon deposits, and fuel consumption.

In addition, the lead-acid battery 1 has the following disadvantages.
1. The cycle life is about 300 deep cycles, and the average life is about 3 years.
2. The lead-acid battery 1 has a low energy density.
3. The lead-acid battery 1 has a large volume.
4. The lead-acid battery 1 has a heavy weight.
5. The lead-acid battery 1 causes an environmental pollution.
6. The lead-acid battery 1 has a poor efficiency when working under a low temperature.

### BRIEF SUMMARY OF THE INVENTION

In accordance with the present invention, there is provided an auxiliary gasoline vehicle booster comprising a box and a first energy storage element mounted in the box. The box has a side provided with an external cord. The external cord is electrically connected in parallel with a generator and a lead-acid battery of a gasoline vehicle. The first energy storage element is electrically connected with the external cord. The first energy storage element is used to receive and store an electric energy supplied by the generator of the gasoline vehicle. The first energy storage element is used to supply an electric power to the gasoline vehicle. The first energy storage element has a voltage ranged between that of the generator and that of the lead-acid battery.

According to the primary advantages of the present invention, the auxiliary gasoline vehicle booster increases the voltage supplied for the power supply system of the gasoline vehicle. In addition, the auxiliary gasoline vehicle booster also filters and supplements the three-phase sine wave voltage generated by the generator of the gasoline vehicle, thereby improving the stability of the power supply system.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart showing of a conventional ignition system of a gasoline car in accordance with the prior art.

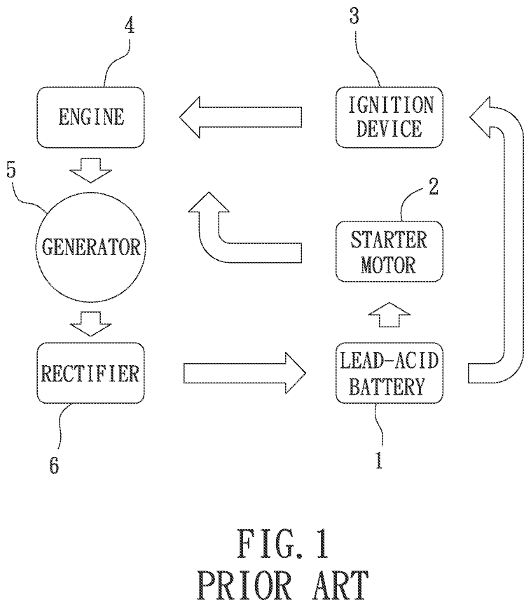

FIG. 2 is a voltage waveform diagram of a generator and a lead-acid battery of the conventional gasoline car.

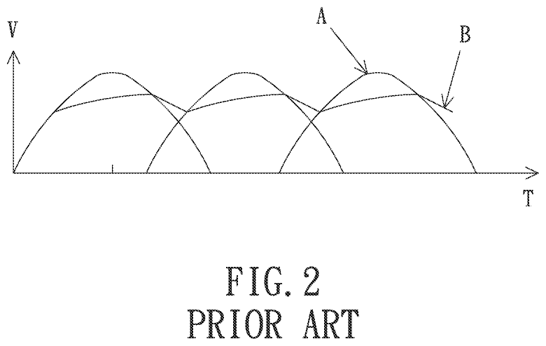

FIG. 3 is a schematic view showing ignition of a spark plug of the conventional gasoline car.

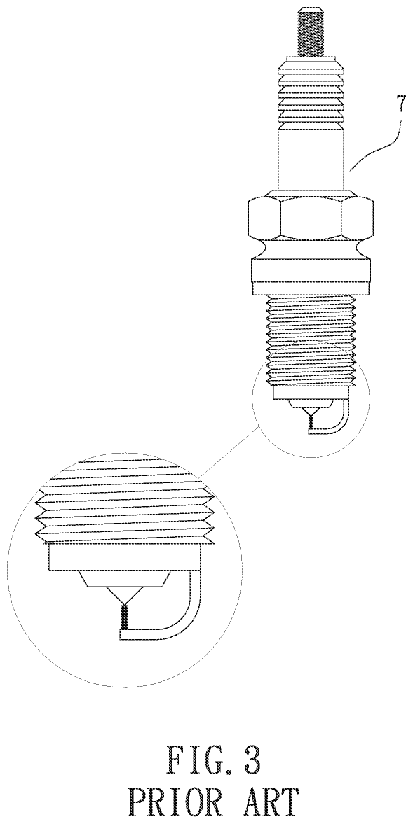

FIG. 4 is a perspective view of an auxiliary gasoline vehicle booster in accordance with the preferred embodiment of the present invention.

FIG. 5 is a circuit diagram of the auxiliary gasoline vehicle booster in accordance with the preferred embodiment of the present invention.

FIG. 6 is a circuit diagram of the auxiliary gasoline vehicle booster connecting a gasoline car.

FIG. 7 is a voltage waveform diagram of the auxiliary gasoline vehicle booster of the present invention.

FIG. 8 is a schematic view showing ignition of a spark plug of the auxiliary gasoline vehicle booster of the present invention.

FIG. 9 is a perspective view of an auxiliary gasoline vehicle booster in accordance with another preferred embodiment of the present invention.

### DETAILED DESCRIPTION OF THE INVENTION

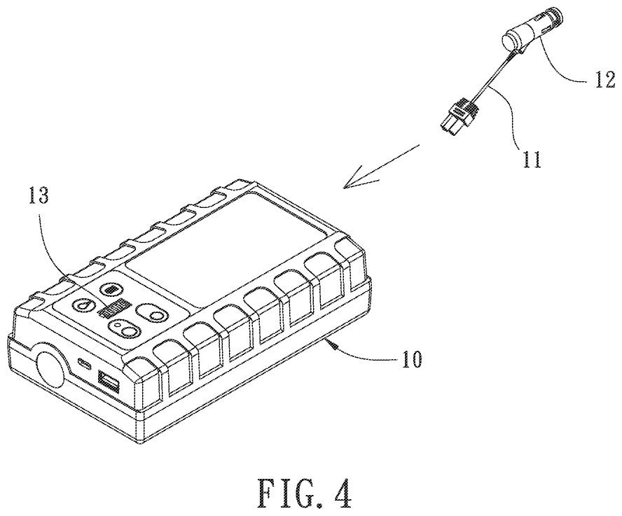

Referring to the drawings and initially to FIGS. 4-6, an auxiliary gasoline vehicle booster in accordance with the preferred embodiment of the present invention comprises a box 10 and a first energy storage element 20 mounted in the box 10.

The box 10 has a side provided with an external cord (or wire or lead) 11. The external cord 11 is electrically connected in parallel with a generator 300 and a lead-acid battery 200 of a gasoline vehicle.

The first energy storage element 20 is electrically connected with the external cord 11. The first energy storage element 20 is used to receive and store an electric energy supplied by the generator 300 of the gasoline vehicle. The first energy storage element 20 is used to supply an electric power to the gasoline vehicle. The first energy storage element 20 has a voltage ranged between that of the generator 300 and that of the lead-acid battery 200.

In the preferred embodiment of the present invention, the first energy storage element 20 is a secondary rechargeable battery.

In the preferred embodiment of the present invention, the secondary rechargeable battery is a lithium iron phosphate battery.

In the preferred embodiment of the present invention, the generator 300 has a voltage of 14.5V, the lead-acid battery 200 has a voltage of 12.4V, and the first energy storage element 20 has a voltage of 13.2V.

In the preferred embodiment of the present invention, the first energy storage element 20 includes multiple lithium iron phosphate battery cores which are connected in series.

In the preferred embodiment of the present invention, the auxiliary gasoline vehicle booster further comprises a second energy storage element 30 mounted in the box 10 and electrically connected with the first energy storage element 20 in parallel.

In the preferred embodiment of the present invention, the second energy storage element 30 includes multiple super capacitors (or ultracapacitors) which are connected in series.

In the preferred embodiment of the present invention, the auxiliary gasoline vehicle booster further comprises two first switches 40 located between the first energy storage element 20 and the second energy storage element 30, and a second switch 50 located between the external cord 11 and the second energy storage element 30. The first switches 40 are mounted in the box 10. Preferably, each of the first switches 40 is an MOS switch. The second switch 50 is mounted in the box 10. Preferably, the second switch 50 is an MOS switch.

In the preferred embodiment of the present invention, the external cord 11 has a distal end provided with a cigarette lighter input connector 12 which is inserted into a cigarette lighter socket of the gasoline vehicle.

In the preferred embodiment of the present invention, the box 10 is a hollow insulator with a square shape, and has the advantages of insulation, impact resistance, and dustproof. The box 10 has an interior provided with a receiving space. The box 10 is provided with an electric quantity indicator 13 to facilitate the user checking the electric power.

In the preferred embodiment of the present invention, the auxiliary gasoline vehicle booster further comprises a microprocessor 60 mounted in the box 10. The microprocessor 60 is electrically connected with the first energy storage element 20, the first switches 40, and the electric quantity indicator 13. The microprocessor 60 is used to handle and detect the first energy storage element 20, to turn on/off the first switches 40, and to indicate the detected electric quantity on the electric quantity indicator 13. Thus, the first switches 40 are turned on/off by the microprocessor 60 to protect the second energy storage element 30.

In the preferred embodiment of the present invention, the lead-acid battery 200, the first energy storage element 20, and the second energy storage element 30 are electrically connected in parallel to function as three energy storage units.

In the preferred embodiment of the present invention, the first energy storage element 20 produces a voltage more than that of the lead-acid battery 200, to produce a boosting effect, and the second energy storage element 30 filters and supplements the three-phase sine wave voltage generated by the generator 300, thereby improving the stability of the power supply system.

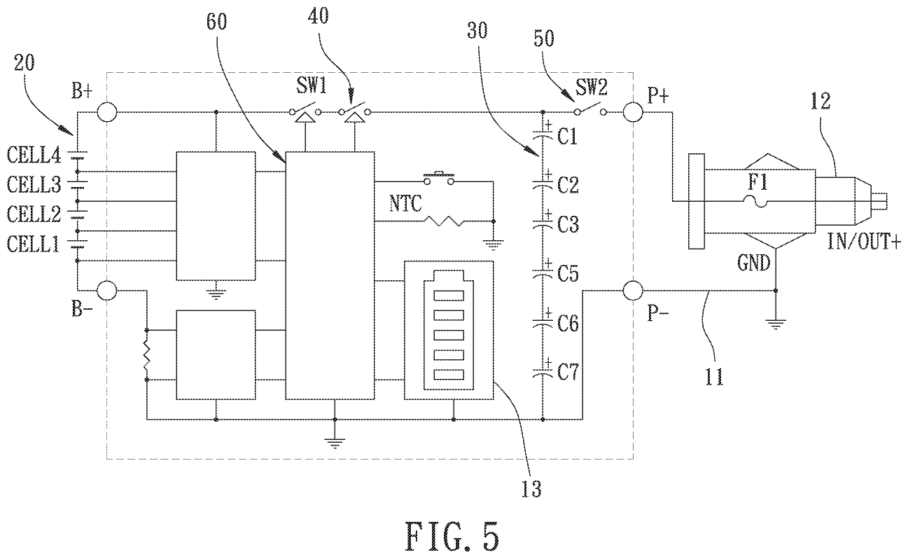

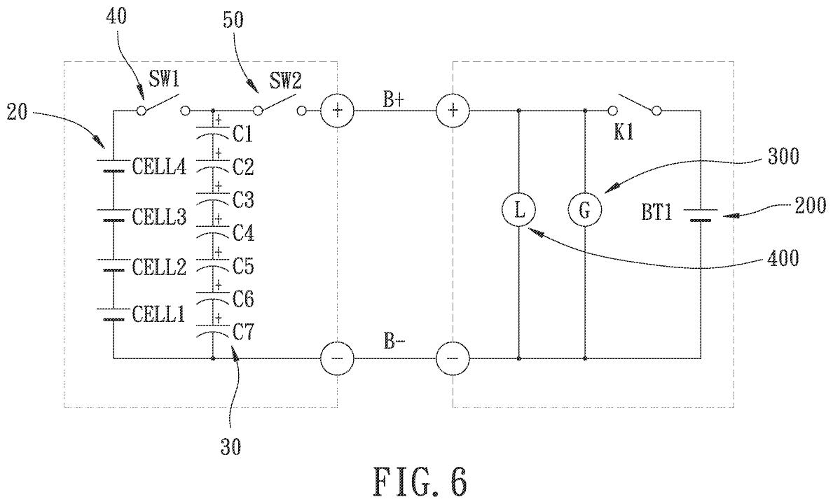

Referring to FIG. 6 with reference to FIGS. 4 and 5, the cigarette lighter input connector 12 of the external cord 11 is inserted into the cigarette lighter socket of the gasoline vehicle. The lead-acid battery 200, the generator 300, and a load 400 of the gasoline vehicle are connected electrically in parallel. The lead-acid battery 200 provides a main electric power and the auxiliary gasoline vehicle booster provides a partial electric power into a starter motor of the gasoline vehicle to drive an engine. The gasoline is atomized and causes a gas explosion in a spark plug to provide a kinetic energy to an engine cylinder. The generator 300 or the lead-acid battery 200 provides a voltage of 12V which is converted into a high voltage by a high voltage coil to ignite the spark plug.

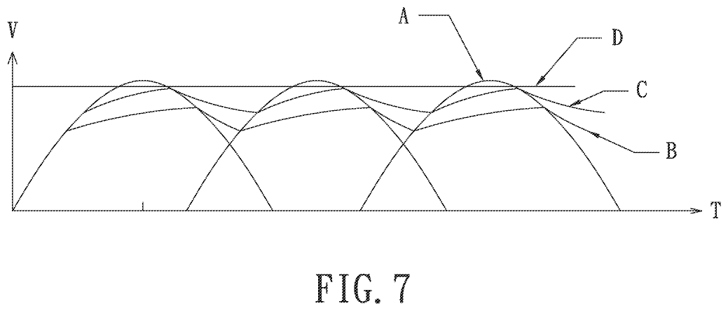

Referring to FIG. 7 with reference to FIGS. 4-6, after the engine is started and operated, the generator 300 is operated and rotated through a belt. The generator 300 produces a waveform of a charging voltage with a phase difference of 120 degrees. The charging voltage produces a voltage waveform A through six commutators in the generator 300. The generator 300 is a three-phase generator and the voltage waveform A is a three-phase sine wave with crests and troughs. An alternating-current voltage is rectified to form the non-pure direct-current voltage waveform A. The generator 300 is responsible for the power supply system of the whole gasoline vehicle and is used to charge the lead-acid battery 200, the first energy storage element 20, and the second energy storage element 30. The lead-acid battery 200 is charged by the generator 300 and forms a voltage waveform B. The first energy storage element 20 is charged by the generator 300 and forms a voltage waveform C. The second energy storage element 30 is charged by the generator 300 and filters the non-DC (direct-current) charging voltage of the generator 300 to form a DC voltage waveform D. As shown in FIG. 7, V is volt and T is time.

When the voltage of the generator 300 is increased to be higher than that of the lead-acid battery 200, the first energy storage element 20, and the second energy storage element 30, the generator 300 can be used to charge the lead-acid battery 200, the first energy storage element 20, and the second energy storage element 30. When the voltage of the generator 300 is decreased gradually to be lower than that of the lead-acid battery 200, the first energy storage element 20, and the second energy storage element 30, the lead-acid battery 200, the first energy storage element 20, and the second energy storage element 30 can be in turn used to charge the load 400 serially.

The voltage waveform D is more than the voltage waveform C which is more than the voltage waveform B as shown in FIG. 7, so that the second energy storage element 30 is the first one for charging the load 400, the first energy storage element 20 is the second one for charging the load 400, and the lead-acid battery 200 is the third one for charging the load 400.

The super capacitors of the second energy storage element 30 have the feature of fast charging and discharging and has a long charging and discharging cycle life, so that the charging and discharging speed of the second energy storage element 30 is much more than that of the first energy storage element 20 and the lead-acid battery 200. Thus, the second energy storage element 30 is the first pick for charging the load 400. The super capacitors of the second energy storage element 30 have a drawback of low energy density, but the first energy storage element 20 has high energy density to complement the second energy storage element 30.

When the second energy storage element 30 of the first pick and the first energy storage element 20 of the second pick have insufficient energy, the lead-acid battery 200 of the third pick will have to charge the load 400. At this time, the voltage of the generator 300 during the next rising waveform is increased to be higher than that of the lead-acid battery 200, the first energy storage element 20, and the second energy storage element 30, to completely charge the second energy storage element 30 of the first pick and the first energy storage element 20 of the second pick, so that the lead-acid battery 200 of the third pick will almost not have to be used to charge the load 400. Thus, the lifetime of the lead-acid battery 200 is prolonged.

In operation, when the gasoline car is turned on by rotating a key, the microprocessor 60 is operated to turn on the second switch 50 for connecting the second energy storage element 30 and turn off the first switches 40 for disconnecting the first energy storage element 20. When the key is further rotated, the lead-acid battery 200 provides a main starting current and the second energy storage element 30 provides an instantaneous auxiliary current through the second switch 50, to trigger and start the starter motor. When the generator 300 is disposed at the crest of the sine wave, the generator 300 charges the lead-acid battery 200 and provides an electric power to the load 400. At this time, the microprocessor 60 is operated to turn on the first switches 40 for connecting the first energy storage element 20. Thus, the generator 300 also charges the second energy storage element 30 through the second switch 50 and charges the first energy storage element 20 through the first switches 40. When the generator 300 is disposed at the trough of the sine wave, the first energy storage element 20 discharges the load 400 and recharges the lead-acid battery 200 through the first switches 40, while the second energy storage element 30 discharges the load 400 and recharges the lead-acid battery 200 through the second switch 50. When the first energy storage element 20 is fully charged, the microprocessor 60 is operated to turn off the first switches 40 automatically for interrupting the first energy storage element 20, to prevent the first energy storage element 20 from being charged excessively. When the first switches 40 are turned off, and the generator 300 is disposed at the crest of the sine wave, the generator 300 charges the second energy storage element 30 through the second switch 50. When the first switches 40 are turned off, and the generator 300 is disposed at the trough of the sine wave, the second energy storage element 30 discharges the load 400 and recharges the lead-acid battery 200 through the second switch 50.

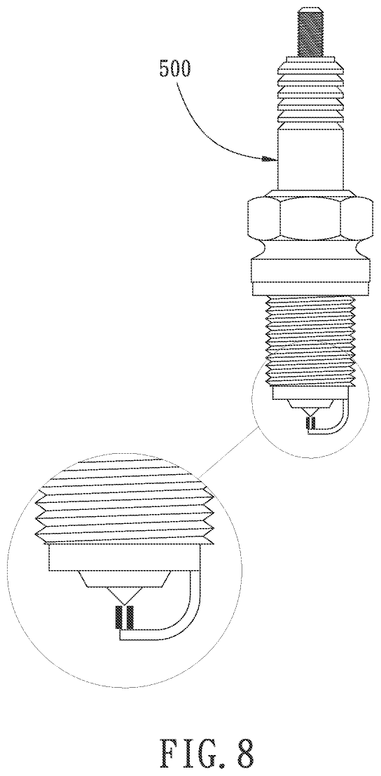

Referring to FIG. 8 with reference to FIGS. 4-6, the gasoline is atomized and causes a gas explosion in the spark plug 500 to provide a kinetic energy to the engine cylinder. The generator 300 or the lead-acid battery 200 provides a voltage of 12V which is converted into a high voltage by a high voltage coil to ignite the spark plug 500. When the second energy storage element 30, the generator 300, and the lead-acid battery 200 are electrically connected in parallel, a steady DC voltage is produced by the second energy storage element 30 and is converted through the high voltage coil into a steady high voltage which is supplied to the spark plug 500. Thus, the high voltage supplied to the spark plug 500 is steady and will not be affected by the high and low waveform of the generator 300, so that the atomized gasoline is burned completely, and the spark plug 500 is ignited steadily.

In addition, the second energy storage element 30 is charged and discharged quickly and has a cycle life of up to 100,000 times, to replenish the electric quantity of the generator 300 instantaneously, so that it is unnecessary for the lead-acid battery 200 to supplement the generator 300, thereby enhancing the lifetime of the lead-acid battery 200 even when the generator 300 gets aged and cannot satisfy the power supply system of the car.

It is appreciated that, the super capacitors of the second energy storage element 30 are worked under a temperature of 85° C. Thus, the second energy storage element 30 cannot be mounted in the engine room that has a high temperature. In such a manner, the cigarette lighter input connector 12 of the external cord 11 is inserted into the cigarette lighter socket of the gasoline vehicle so that the second energy storage element 30 is worked under a lower temperature and is electrically connected with the lead-acid battery 200 in parallel.

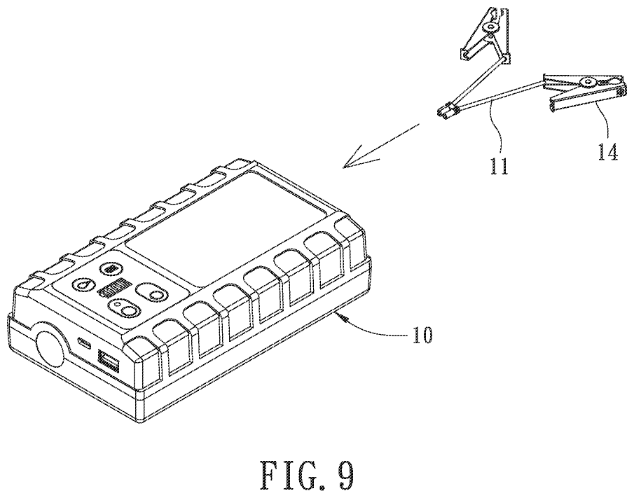

Referring to FIG. 9 with reference to FIGS. 4-6, the external cord 11 has a distal end provided with a gasoline vehicle rescue chuck set 14 which is clamped on the electrodes of a lead-acid battery of a gasoline vehicle to be rescued. Thus, the auxiliary gasoline vehicle booster is electrically connected in parallel with the lead-acid battery of the gasoline vehicle to be rescued to provide an electric power required for starting the engine.

Accordingly, the auxiliary gasoline vehicle booster has the following advantages.

1. When the generator 300 gets aged, the generator 300 cannot provide an enough power to ignite the spark plug 500, thereby decreasing the ignition efficiency of the spark plug 500. At this time, the first energy storage element 20 has a voltage more than that of the lead-acid battery 200 to lift the whole voltage of the power supply system of the gasoline vehicle, so that the first energy storage element 20 will first provide an enough power to ignite the spark plug 500, thereby increasing the ignition efficiency of the spark plug 500.

2. The second energy storage element 30 has a large capacity and has a charging and discharging speed more than that of the lead-acid battery 200, so that when the load 400 needs a large electric quantity instantaneously, the second energy storage element 30 satisfies the requirement of the power supply system instantaneously, to stabilize the power supply system of the whole gasoline vehicle.

In addition, the auxiliary gasoline vehicle booster has the following effects.
1. The auxiliary gasoline vehicle booster improves the gasoline combustion efficiency.
2. The auxiliary gasoline vehicle booster extends the life of the lead-acid battery 200.
3. The auxiliary gasoline vehicle booster improves the ignition stability of the spark plug 500.
4. The auxiliary gasoline vehicle booster reduces the vibration caused by gasoline vehicle when climbing.
5. The gasoline is burned completely to reduce the carbon emission.
6. The auxiliary gasoline vehicle booster is operated easily without needing professional installation.

Further, the first energy storage element 20 with the lithium iron phosphate battery has the following features.
1. The cycle life of the first energy storage element 20 is 3,000 times.
2. The first energy storage element 20 has an energy density more than that of the lead-acid battery 200.
3. The first energy storage element 20 has a low self-discharge rate.
4. The first energy storage element 20 does not explode when being penetrated, with a high safety.

Further, the second energy storage element 30 with the super capacitors has the following features.
1. The cycle life of the second energy storage element 30 is 100,000 times.
2. The second energy storage element 30 has a high instantaneous power density.
3. The second energy storage element 30 has fast charging and discharging speed.
4. The second energy storage element 30 is worked un a low temperature.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An auxiliary gasoline vehicle booster comprising:
a box; and
a first energy storage element mounted in the box;
wherein:
the box has a side provided with an external cord;
the external cord is electrically connected in parallel with a generator and a lead-acid battery of a gasoline vehicle;
the first energy storage element is electrically connected with the external cord;
the first energy storage element is used to receive and store an electric energy supplied by the generator of the gasoline vehicle;
the first energy storage element is used to supply an electric power to the gasoline vehicle; and
the first energy storage element has a voltage ranged between that of the generator and that of the lead-acid battery.

2. The auxiliary gasoline vehicle booster as claimed in claim 1, wherein the first energy storage element is a secondary rechargeable battery.

3. The auxiliary gasoline vehicle booster as claimed in claim 2, wherein the secondary rechargeable battery is a lithium iron phosphate battery.

4. The auxiliary gasoline vehicle booster as claimed in claim 1, wherein:
the generator has a voltage of 14.5V;
the lead-acid battery has a voltage of 12.4V; and
the first energy storage element has a voltage of 13.2V.

5. The auxiliary gasoline vehicle booster as claimed in claim 4, wherein the first energy storage element includes multiple lithium iron phosphate battery cores which are connected in series.

6. The auxiliary gasoline vehicle booster as claimed in claim 1, further comprising:
a second energy storage element electrically connected with the first energy storage element in parallel.

7. The auxiliary gasoline vehicle booster as claimed in claim 6, wherein the second energy storage element includes multiple super capacitors which are connected in series.

8. The auxiliary gasoline vehicle booster as claimed in claim 6, further comprising:
two first switches located between the first energy storage element and the second energy storage element; and
a second switch located between the external cord and the second energy storage element.

9. The auxiliary gasoline vehicle booster as claimed in claim 1, wherein the external cord has a distal end provided with a cigarette lighter input connector which is inserted into a cigarette lighter socket of the gasoline vehicle.

10. The auxiliary gasoline vehicle booster as claimed in claim 1, wherein the external cord has a distal end provided with a gasoline vehicle rescue chuck set which is clamped on electrodes of the lead-acid battery of the gasoline vehicle.
